(19) United States
(12) Patent Application Publication
(10) Pub. No.: US 2017/0126846 A1
(43) Pub. Date: May 4, 2017

(54) NETWORK COMMUNICATION SYSTEM

(71) Applicant: VTX HOLDINGS (Singapore) Pte. Ltd., Singapore (SG)

(72) Inventors: Robert William Pole, Torbay (NZ); Cameron Brett Worth, Subiaco (AU)

(73) Assignee: VTX HOLDINGS (Singapore) Pte. Ltd., Singapore (SG)

(21) Appl. No.: 14/927,462

(22) Filed: Oct. 29, 2015

(51) Int. Cl. H04L 29/06; H04L 12/46

(52) U.S. Cl. CPC H04L 69/04; H04L 69/16; H04L 69/22; H04L 12/4641; H04L 12/4633

(57) ABSTRACT

A network communication system for communicating data from a source network location to a destination network location is disclosed. The system comprises a source network device and a destination network device. The source network device has a source control packet manager that detects a source data packet when the source data packet is received at the source network device from a remote network device, generates a forged response control packet in response to detection of the source data packet, and sends the forged response control packet to the remote network device. The destination network device detects a destination response packet sent from the destination location in response to reception of the source control packet at the destination location, and prevents sending of the destination response packet to the remote location.

### FIELD OF THE INVENTION

The present invention relates to a network communication system, and in particular to a communication system for improving network bandwidth in Internet communications.

### BACKGROUND

The Internet is a very large scale internet protocol (TCP/IP) based data network that is used to communicate information between computing devices, including personal computers, tablet computers and smartphones. Such information may be time critical or non-time critical.

Non-time critical information is typically communicated through the Internet using TCP protocol, which includes quality of service measures that operate to guarantee delivery of accurate data. If any data packets do not arrive safely at a destination, the packets are resent. TCP is for example typically used for Internet browsing, email and file transfer applications.

Time critical information is typically communicated through the Internet using UDP protocol, which does not include quality of service measures such as guarantee of delivery and as such any packets that do not arrive on time are lost. UDP is for example typically used for real-time audio/visual communications.

When information is passed to a user computing device from a remote server, the information typically passes from the remote server through several networks and routing devices to the user computing device, and typically a significant determining factor in the overall bandwidth available between the server and user computing device is the bandwidth available through a section of the communication path that is adjacent the user computing device. This section of the communication path is referred to in this specification as the ‘last mile’ of the communication path.

In typical Internet communications, such as TCP communications, when a packet is received at a destination device from a source device, the destination device sends a response control packet to the source device. However, since the response control packets are used by the source device to determine the appropriate packet send rate to use, the effect is that the speed of communications through the entire communication path is dependent on the speed of communications across the last mile.

### SUMMARY

In accordance with a first aspect of the present invention, there is provided a network communication system for communicating data from a source network location to a destination network location, the system comprising:

a source network device comprising a source control packet manager for managing control packets that pass between the source and destination locations;

the source network device arranged to detect a source data packet when the source data packet is received at the source network device from a remote network device, and the source control packet manager generating a forged response control packet in response to detection of the source data packet;

the source network device arranged to send the forged response control packet to the remote network device;

a destination network device arranged to detect a destination response packet sent from the destination location in response to reception of the source data packet at the destination location, and to prevent sending of the destination response packet to the remote location;

wherein the forged response control packet emulates the destination response packet.

In an embodiment, the source network device is arranged to add a custom packet header to the source data packet, the custom packet header including a forged packet flag, the destination network device detecting the forged packet flag and in response preventing sending of the destination response packet to the remote location when the destination response packet sent from the destination location is detected by the destination network device.

In an embodiment, the source network device comprises at least one source application arranged to implement at least generation of a forged response control packet in response to detection of the source data packet.

In an embodiment, the source network device comprises a source TUN interface arranged to provide an interface between a kernel of the source network device and the source application.

In an embodiment, the source application is downloadable and installable on a source computing device so as to at least partially implement the source network device on the source computing device.

In an embodiment, the destination network device comprises at least one destination application arranged to implement at least detection of a destination response packet sent from the destination location in response to reception of the source data packet at the destination location, and prevention of sending of the destination response packet to the remote location.

In an embodiment, the destination network device comprises a destination TUN interface arranged to provide an interface between a kernel of the destination network device and the destination application.

In an embodiment, the destination application is downloadable and installable on a destination computing device so as to at least partially implement the destination network device on the destination computing device.

In an embodiment, the source network device comprises a source VPN network interface and the destination network device comprises a destination VPN network interface, the source and destination VPN network interfaces creating a VPN tunnel between the source and destination network devices. The VPN tunnel may be arranged to use a base SSL connection.

In an embodiment, payload data of the source packet is compressed using ASCII compression. In response to compression of source packet payload data using ASCII compression, the source network device may be arranged to add an ASCII compression flag to the custom packet header.

In an embodiment, the destination network device is arranged to detect the ASCII compression flag in the custom packet header, and in response to decompress the associated ASCII compressed payload data.

In an embodiment, the source network device is arranged to compress the payload data using a data compression algorithm. A plurality of data compression algorithms may be available and the source network device may be arranged to select a data compression algorithm based on defined criteria. The data compression algorithms may include a ZLib compression algorithm and a Brotli compression algorithm.

In an embodiment, the custom header includes data indicative of the type of custom packet.

In accordance with a second aspect of the present invention, there is provided a source network device for communicating data to a destination network device, the source network device comprising:

a source control packet manager for managing control packets that pass between the source and destination locations;

the source network device arranged to detect a source data packet when the source data packet is received at the source network device from a remote network device, and to generate a forged response control packet in response to detection of the source data packet; and

the source network device arranged to send the source data packet to the destination location and to send the forged response control packet to the remote network device.

In accordance with a third aspect of the present invention, there is provided a server computing device comprising a source network device according to the second aspect of the present invention. The source network device may be implemented at least partially by a server application that may be downloaded and installed on the server computing device.

In accordance with a fourth aspect of the present invention, there is provided a destination network device for receiving data communicated from a source network device, the destination network device arranged to detect a destination response packet sent from a destination location in response to reception of the source control packet at the destination location, and to prevent sending of the destination response packet to the remote location, wherein the forged response control packet emulates the destination response packet.

In accordance with a fifth aspect of the present invention, there is provided a client computing device comprising a destination network device according to the fourth aspect of the present invention. The destination network device may be implemented at least partially by a client application that may be downloaded and installed on the client computing device.

In the above embodiments, the source network device may be arranged to implement functionality associated with the destination network device, and the destination network device may be arranged to implement functionality associated with the source network device.

### DESCRIPTION OF THE DRAWINGS

The present invention will now be described, by way of example only, with reference to the accompanying drawings, in which:

FIG. 1 is a diagrammatic representation of a typical Internet network arrangement that supports TCP/IP communications;

FIG. 2 is a conceptual overview block diagram of a network communication system in accordance with an embodiment of the present invention;

FIG. 3 is a block diagram of the network communication system shown in FIG. 2 illustrating components of the system;

FIG. 4 is a block diagram of a packet buffer manager of the system shown in FIG. 3;

FIG. 5 is a block diagram of a control packet manager of the system shown in FIG. 3;

FIG. 6 is a flow diagram illustrating processing packets at a VPN server end of a VPN tunnel of the system shown in FIG. 3;

FIG. 7 is a flow diagram illustrating a method of processing packets at a client end of the VPN tunnel of the system shown in FIG. 3; and

FIG. 8 is a block diagram of reliability components of the system shown in FIG. 3.

### DETAILED DESCRIPTION

For the purpose of this specification the term ‘inbound’ refers to data that travels to the client device 14 from a remote server, and the term ‘outbound’ refers to data that travels from the client device 14 to the remote server.

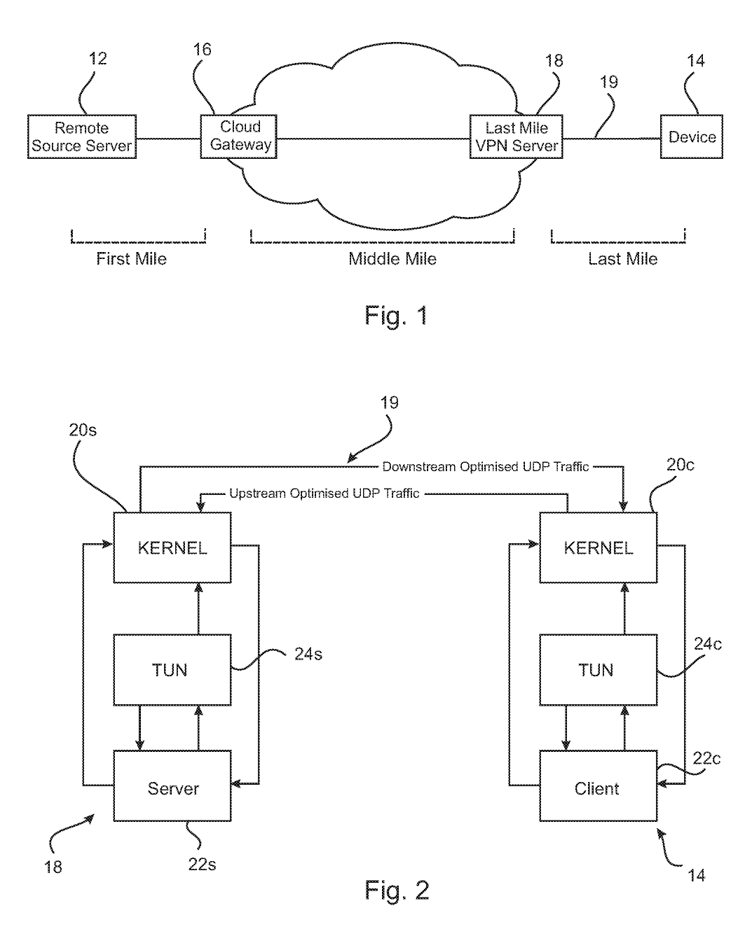

Referring to FIG. 1 of the drawings, an arrangement is shown that represents a typical communications arrangement across the Internet wherein a remote server 12 communicates with a client computing device 14, such as a personal computer, tablet computer or smartphone. In this example, a communication from the remote server 12 passes through a cloud gateway 16 and a VPN server 18 that is arranged to connect with the client device 14 through a virtual private network (VPN). The VPN establishes a network tunnel 19 between the VPN server 18 and the client device 14 that facilitates secure communications to and from the client device 14 across the tunnel 19. In the present specification, the terms ‘VPN connection’ and ‘tunnel’ are used interchangeably.

The present system provides a degree of optimisation of communications between the client device 14 and the VPN server 18 in order to avoid throttling of the packet transmission rate through the ‘first mile’ and ‘middle mile’ of the communication path because of low bandwidth at the ‘last mile’ of the communication path adjacent the client device 14.

The VPN server 18 and the client device 14 are shown conceptually in FIG. 2. The client device 14 includes a client kernel 20c, a client application 22c and a TUN interface 24c arranged to provide a virtual interface for network data between the kernel 20c and the client application 22c. Similarly, the VPN server includes a VPN server kernel 20s, a server application 22s and a TUN interface 24s arranged to provide a virtual interface for network data between the kernel 20s and the server application 22s.

During use, data that is desired to be sent over the network through the tunnel 19 is passed to the client/server application 22c, 22s through the relevant TUN interface 24c, 24s by the relevant kernel 20c, 20s, and the client/server application processes the network data and passes the data back to the kernel through the TUN interface 24c, 24s for transmission.

At the opposite side of the tunnel 19, the relevant kernel 20c, 20s passes the custom packets through the relevant TUN interface 24c, 24s to the relevant client or server application 22c, 22s which processes the custom packets, and passes the packets back to the relevant kernel through the relevant TUN interface 24c, 24s for onward transmission to the relevant remote server 12 or client device 14.

Processing of the data at the VPN server 18 involves creating a forged response packet in response to reception at a server side of the VPN tunnel 19 of a packet from the server 12, and sending the forged response packet back to the server 12. The forged response packet mirrors a response packet that would be sent to the server 12 from the client 14 when a packet from the server 12 is received at the client 14. In this way, the server 12 receives a response control packet in respect of a packet before the packet has passed over the tunnel 19 to the client device 14, and the packet send rate from the server 12 is determined by the bandwidth across the first mile and middle mile and not the last mile of the communication path.

After sending the forged response packet, a custom packet header is created for the associated received packet and added to the packet to create a custom packet. The custom header includes information to indicate to other components of the system that a forged packet has been sent in respect of the packet.

The custom packets may be buffered at the VPN server 18 and individually compressed prior to communication through the tunnel 19.

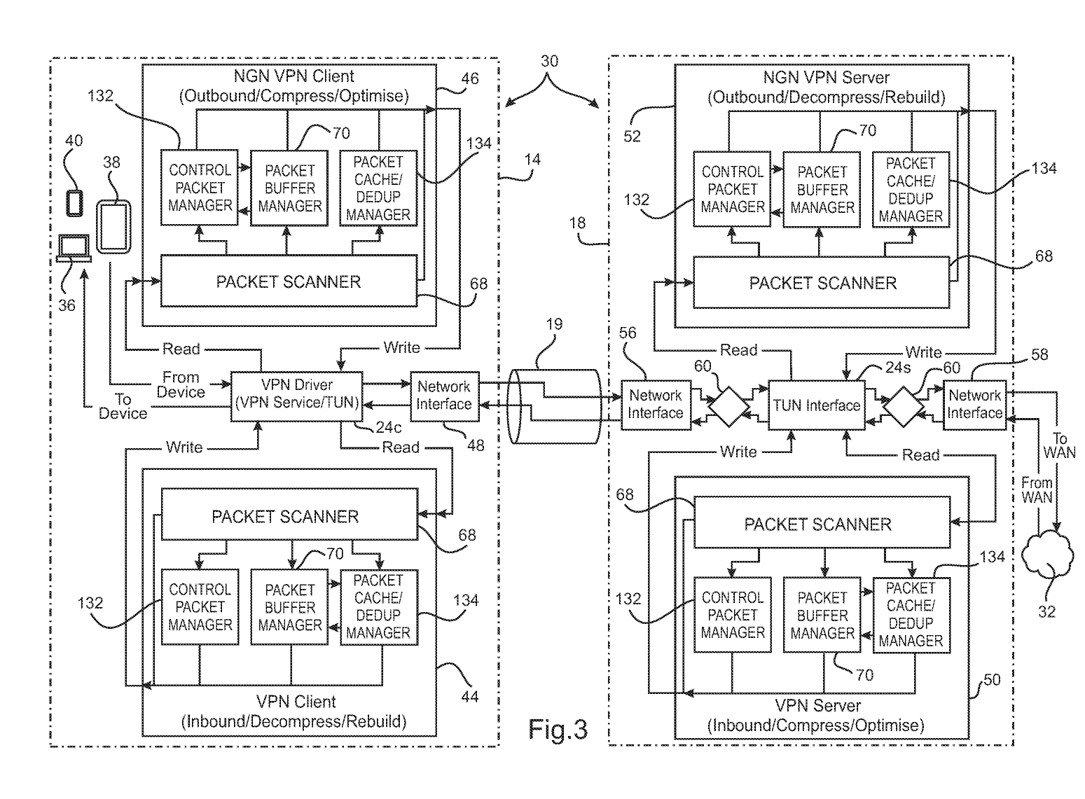

Referring to FIG. 3, components of a network communication system 30 are shown in more detail. Like and similar features are indicated with like reference numerals.

The system 10 includes a client device 14 that communicates with a VPN server 18 through a VPN tunnel 19 that has been established by the client device 14 and VPN server 18. As indicated above, the VPN tunnel 19 extends across the ‘last mile’ of the communication path between the client device 14 and a remote server (not shown) that for example is in communication with the client device 14 through a WAN 32.

As indicated, the client device 14 may take the form of a personal computer 36, tablet computer 38 or smartphone 40, although it will be understood that any suitable computing device is envisaged. It will be understood that the client device is shown conceptually in FIG. 3 and while the client device 14 may for example be a personal computer 36, tablet computer 38 or smartphone 40, the components of the client device 14 illustrated in FIG. 3 would be incorporated in and form part of the personal computer 36, tablet computer 38 or smartphone 40.

The client device 14 includes an inbound packet manager 44 and an outbound packet manager 46 that are arranged to perform complimentary functions for data that travels in different directions across the tunnel 19. The packet managers 44, 46 in this example are implemented using a client application that is installed on the client device 14, and the packet managers 44, 46 are arranged to process data that is sent across the tunnel 19, including creating custom packet headers, generating forged control packets, compressing the packets before entry into to the tunnel 19, decompressing packets that are received from the tunnel 19, and managing control aspects of packet transfer across the network.

Each of the packet managers 44, 46 communicates with a VPN driver that serves as a TUN interface 24c arranged to facilitate passage of data packets between the client device kernel 20c and the client application represented in this example by the packet managers 44, 46. Data packets that are passed to the client device kernel 20c by the TUN interface 24c are transferred to the physical network (and thereby the VPN tunnel 19) through a network interface 48 if the data packets are outbound data packets, or to a device application running on the client device 14, such as an Internet browser, that is in communication with the remote server 12 and receiving data packets from the remote server 12.

The VPN server 18 may take the form of a personal computer or dedicated computer server, although it will be understood that any suitable computing device is envisaged.

The VPN server 18 includes an inbound packet manager 50 and an outbound packet manager 52 that are arranged to perform complimentary functions for data that travels in different directions across the tunnel 19. The packet managers 50, 52 in this example are implemented using a server application that is installed on the VPN server 12, and, in a similar way to the packet managers 44, 46 of the client device 14, the packet managers 50, 52 are arranged to process network data that is sent across the tunnel 19, including creating custom packets, generating forged control packets, compressing the custom packets, decompressing custom packets that are received from the tunnel 19, and managing control aspects of packet transfer across the network.

Each of the packet managers 50, 52 communicates with a TUN interface 54 arranged to facilitate passage of data packets between the VPN server kernel 20s and the server application represented in this example by the packet managers 50, 52. Data packets that are passed to the VPN server kernel 20s by the TUN interface 24s are transferred to the physical network and the VPN tunnel 19 through a tunnel network interface 56, or to the physical network and the WAN and ultimately the remote server 12 through a WAN network interface 58.

The VPN server 18 also includes routing devices 60 arranged to carry out appropriate IP routing as required.

Each of the packet managers 44, 46, 50, 52 includes a packet scanner 68, in this example implemented using an ASCII processor, that analyses each incoming original source packet and determines the most appropriate action to carry out in respect of the packet, for example whether to compress using ASCII compression, or whether to apply other compression methodologies described in more detail below. The packet scanner 68 also analyses the incoming source packet to determine packet type, for example whether the source packet is a TCP type packet, a UDP type packet, a control packet, or a packet that is latency sensitive and therefore should be passed over the network without delay.

Each packet manager 44, 46, 50, 52 also includes a packet buffer manager 70 arranged to build custom packets, compress the payload data in the custom packets according to the compression regime determined by the packet scanner 68, trigger generation of a forged control packet, rebuild original source packets, and decompress payload data in the custom packets.

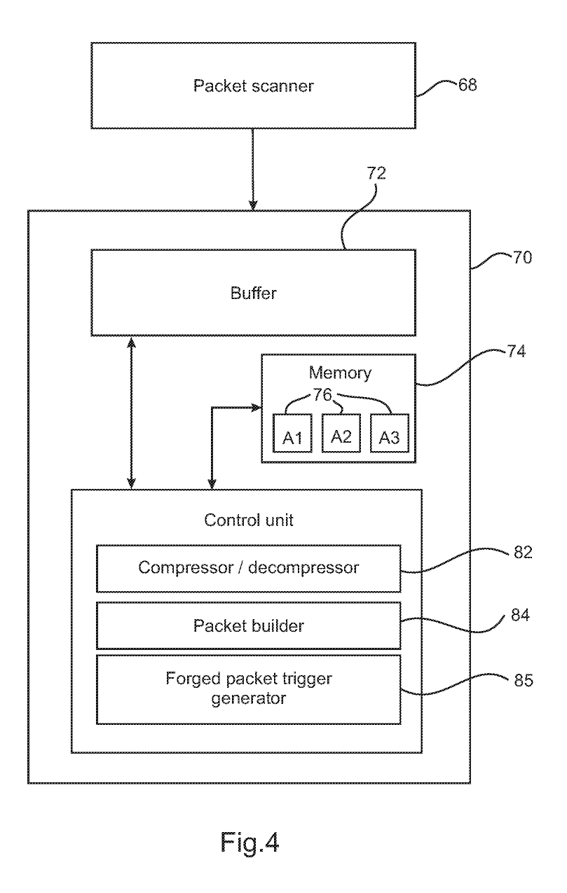

Components of the packet buffer manager 70 are shown in more detail in FIG. 4. The packet buffer manager 70 includes a buffer 72 arranged to receive and temporarily store source packets; a memory 74 arranged to store information indicative of several compression regimes 76, including ASCII compression, ZLib compression and Brotli compression; and a control unit 78 arranged to control and coordinate operations in the packet buffer manager 70.

The control unit 78 in this example is arranged to implement several functions and for this purpose the control unit includes or otherwise implements a compressor/decompressor 82 arranged to apply ASCII and other compression and decompression regimes to the source packet payload data, a packet builder 84 arranged to construct custom packets that include compressed payload data and a custom header, and a forged packet trigger generator 85 arranged to send a signal to cause generation of a forged control packet to be sent to the remote server 12 when a packet is received in the packet buffer 70 from the server 12.

The custom header in this example includes the following header fields:
ProtocolID
CodecFlags
ProtocolFlags

The ProtocolID field provides an indication as to the type of packet, and in this example the packet type may be any one of the following:
111: Error/Reconnect
200: Authenticate/Handshake
201: Control packet
202: Compressed buffer
203: Cache hit/Duplicate
204: Untouched/Raw UDP packet
205: Untouched/Raw TCP packet

The CodecFlags field contains flags indicative of the compression/decompression regime that has been used in relation to the payload.

In the present example, the CodecFlags field includes the following bits:
PacketCodec (ASCII)
BufferCodec (LZ)
BufferCodec (Brotli)

A ‘1’ in a PacketCodec flag indicates that the respective source payload has been compressed with ASCII compression; a ‘1’ in a BufferCodec field indicates that the respective codec has been used to compress the payload data.

The ProtocolFlags field contains flags indicative of special packet types and/or features that relate to network functionality, and in this example the ProtocolFlags field includes a ResponseForged flag indicative of whether a forged control packet has been generated and sent by the VPN server 18 to the remote server 12. A ‘1’ in a ResponseForged flag indicates that the forged control packet has been sent.

Other fields may be included in the custom header as appropriate for operation of a packet network such as the Internet.

Each packet manager 44, 46, 50, 52 also includes a control packet manager 132 that manages control packets passing between the client device 14 and the remote server 12, the control packets containing control, routing and scheduling information required for correct operation of a packet network; and that generates forged control packets in response to a trigger signal received from the packet buffer 70.

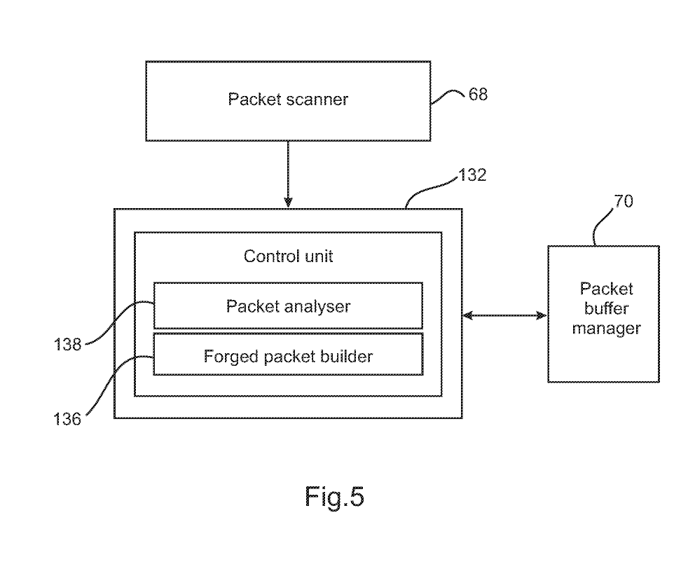

The control packet manager 132 is shown in more detail in FIG. 5. The control packet manager 132 communicates with the packet scanner 68 and the packet buffer manager and includes a control unit 134 arranged to control and coordinate operations in the control packet manager 132. The control unit 134 includes or is arranged to implement a forged packet builder 136 arranged to create a forged control packet that simulates a control packet that would be received at the remote server 12 in response to receipt from the remote server 12 of a packet at the client device 14. The control unit 134 also includes or is arranged to implement a packet analyser 138 arranged to determine, in this example at the client side of the tunnel 19, whether a ResponseForged flag is present in the packet header and therefore whether a forged control response has been sent for the packet.

Each packet manager 44, 46, 50, 52 also includes a packet cache manager 134 arranged to avoid duplication of transmission of data when the same data previously sent to the client device 14 or VPN server 18 is required at a subsequent time by the client device 14 or VPN server 18.

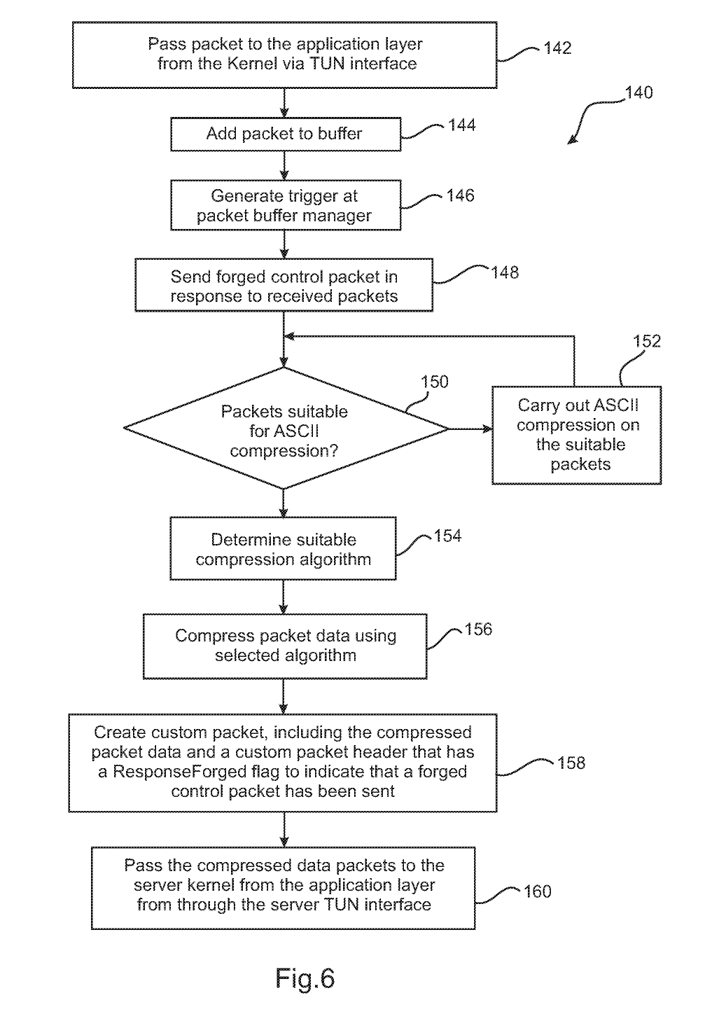

Referring to FIG. 6, a flow diagram 140 is shown that illustrates a method of processing packets as source packets arrive from the remote server 12 for transmission through the tunnel 19 to the client device 14.

On arrival at the relevant server kernel 20s of the VPN server 20s, the source packets are passed 142 to the application layer through the server TUN interface 24s for processing by the server application 22s. During processing, the received source packets are identified as packets containing payload data by the packet scanner 68 and added 144 to the buffer 72 of the packet buffer manager 70. In response to receipt of a packet containing payload data at the buffer 72, the forged packet trigger generator 85 of the packet buffer manager 70 generates and sends 146 a trigger signal to the control packet manager 132 to cause the control packet manager 132 to send 148 a forged control packet to the remote server 12.

As indicated at steps 150 and 152, if any of the source packets are suitable for ASCII compression, as identified by the packet scanner 68, ASCII compression is applied to the source packets and an appropriate flag added to the CodecFlags field of the custom header.

As indicated at step 154, the packet scanner 68 analyses the incoming source packets and determines the most appropriate compression algorithm to use to compress the data in a data packet. In this example, two compression algorithms are available: Broth compression, that is used as the primary compression algorithm, and ZLib compression, that is used for particular versions of client/VPN server applications 22c, 22s, JAVA versions of the client/VPN server applications 22c, 22s, and when the load on the VPN server 18 is approaching an upper limit threshold. After selection of the most appropriate compression algorithm, the selected algorithm is applied 156 to the packet payload data by the compressor/decompressor 82 to produce compressed payload data. A custom packet is then created 158 that includes the compressed data and a custom header with the appropriate codec flag added to the CodecFlags field and a TRUE flag added to the ResponseForged flag. The created custom packets are passed to the server kernel 20s through the server TUN interface 24s for transmission through the tunnel 19 to the client device 14.

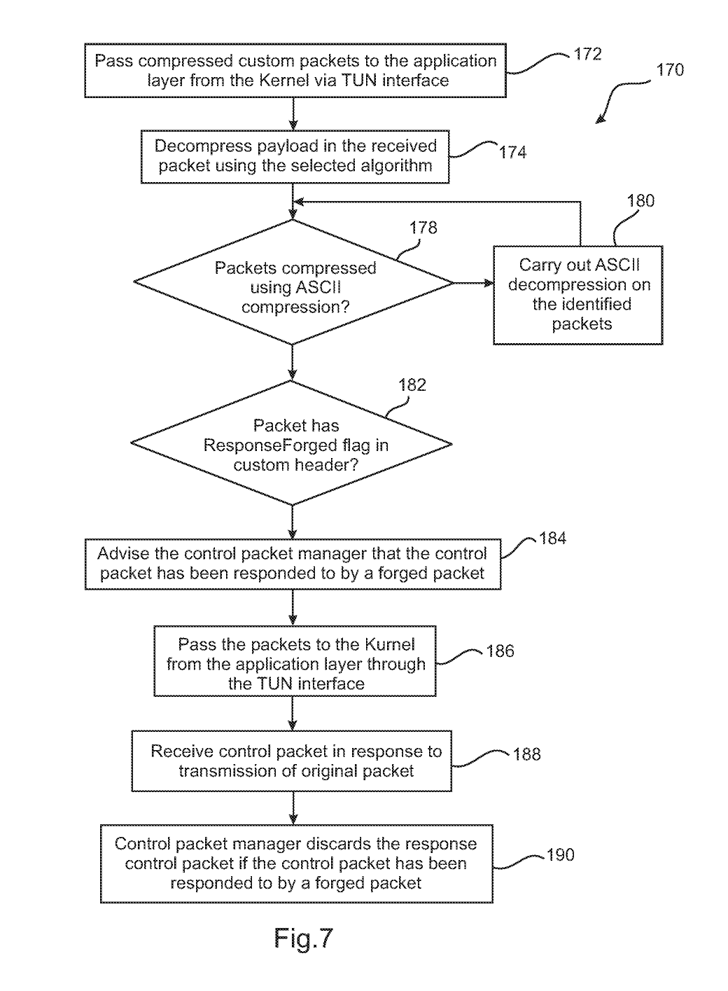

Referring to FIG. 7, a flow diagram 170 is shown that illustrates a method of processing custom packets as the custom packets pass out of the tunnel 19 and are received at the client device 14.

After passing through the tunnel 19 and arriving at the client kernel 20c of the client device 14, the packet is passed 172 to the application layer through the client TUN interface 24c for processing by the client application 22c. The received custom packet is decompressed 174 by the compressor/decompressor 82 using the selected compression algorithm and, as indicated at steps 178 and 180, if the packet was compressed using ASCII compression, the packet is decompressed.

The packet is then analysed 182 by the packet buffer manager 70 and if a TRUE ResponseForged flag is detected, a call 184 is made to the control packet manager 132 to cause the control packet manager 132 to block the associated control packet that will issue from the client device 14 in response to receipt of the packet from the remote server 12. The decompressed packet is then passed 186 to the relevant client kernel 20c through the client TUN interface 24c for transmission to the client device 14.

When the actual control packet issues from the client device in response to receipt of the packet from the remote server 12 and is received 188 at the buffer 72 of the packet buffer manager 70, the control packet manager 132 discards 190 the actual control packet.

A similar process occurs when a packet is sent from the client device 14 through the tunnel 19 to the remote server 12.

It will be appreciated that by sending forged control packets to the remote server 12 from a location before the tunnel 19 in response to receipt of packets from the remote server 12, the maximum amount of data is transmitted from the remote server across the first mile and middle mile of the communication path between the remote server 12 and the client device 14. This allows the buffer 70 at the entry side of the tunnel 19 to be filled at a maximum rate without regard to the speed on the last mile. This also allows much of the control associated with TCP to be limited at the client device 14.

It will be understood that the packet scanner 68 is responsible for making decisions in relation to the actions to carry out on a source packet or custom packet 90.

For example, for custom packets that exit the tunnel 19, the packet scanner uses the ProtocolID field in the custom header to determine routing/handling actions to be carried out on the packet:

| | |
|---|---|
| 111: Error/Reconnect | Drop packet—handled by VPN layer |
| 200: Authenticate/Handshake | Drop packet—handled by VPN layer |
| 201: Control packet | Pass packet to control packet manager |
| | 132 |
| 202: Compressed buffer | Pass packet to packet buffer manager |
| 203: Cache hit/Duplicate | Pass packet to cache/deduplication |
| | manager |
| 204: Untouched/Raw UDP | Bypas—send directly to TUN |
| packet | interface |
| 205: Untouched/Raw TCP | Bypas—send directly to TUN |
| packet | interface |

Packets that are considered to be latency sensitive prior to entry into the tunnel 19 are cached and sent directly to the TUN interface 24c, 24s. Such latency sensitive packets are typically associated with RPC traffic, including traffic associated with gaming that would significantly affect user experience if latency were introduced through buffering and compression. Latency sensitive packets are identified when codecs 204 and 205 exist in the custom packet header.

Packets that are identified as control packets are not cached or compressed; they are routed to the control packet manager 132 for processing. Control packets are identified using protocol headers in the source packet header. For example, a TCP header includes ACK, SYN and FIN features. A high performance database is maintained in the packet scanner 68 and is used to facilitate quick identification of control packets and improved system performance.

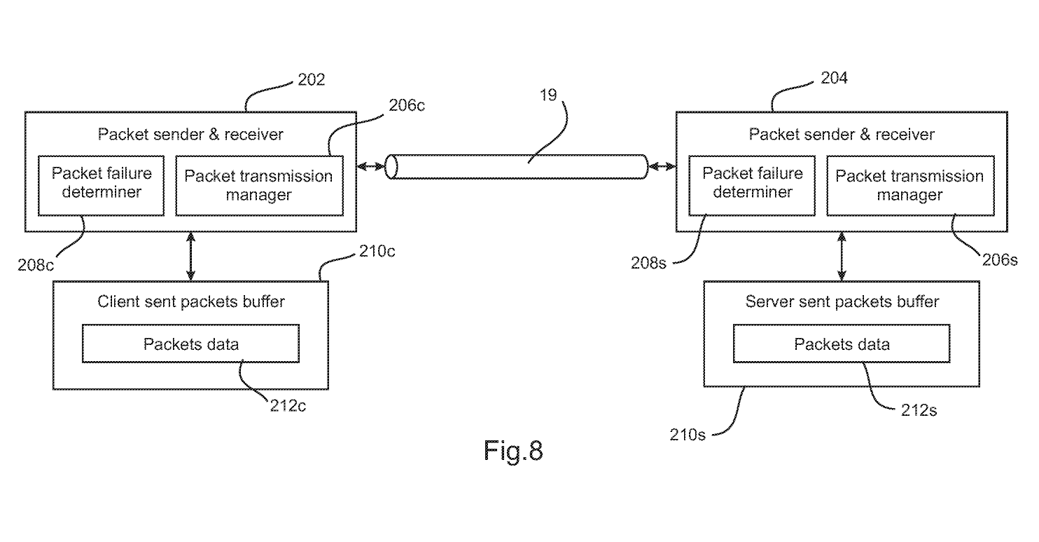

Referring to FIG. 8, a block diagram of reliability and congestion control components 200 for packet transmissions through the tunnel 19 is shown. The components 200 are implemented at the tunnel layer.

The components 200 include a client packet sender and receiver 202 and a server packet sender and receiver 204. Each packet sender and receiver 202, 204 includes a packet transmission manager 206c, 206s arranged to control and coordinate sending and receiving of custom packets through the tunnel 19 when the custom packets are passed to the relevant kernel 20c, 20s by the relevant TUN interface 24c, 24s; and a packet failure determiner 208c, 208s arranged to handle errors in transmission of the custom packets and in particular to make determinations as to whether retransmission of a custom packet is required.

The components also include a client sent packets buffer 210c and a server packet sent buffer 210s, each of which is arranged to cache sent packets in a respective packet data buffer 212c, 212s. The packet data buffers 212c, 212s are used when packets are required to be resent across the tunnel 19.

According to conventional VPN regimes, the system 30 also encrypts the custom packets 90 prior to sending across the tunnel 19 and decrypts the packets as they are received at the other side of the tunnel 19. In the present example, all key exchanges required for encryption occur over a base SSL connection. If no SSL certificates are in place, the VPN service will prevent connection to the VPN and prompt the user to open the client or server application 22c, 22s.

Modifications and variations as would be apparent to a skilled addressee are deemed to be within the scope of the present invention.

The embodiments of the invention in which an exclusive property or privilege is claimed are defined as follows:

1. A network communication system for communicating data from a source network location to a destination network location, the system comprising:
a source network device comprising a source control packet manager for managing control packets that pass between the source and destination locations;
the source network device arranged to detect a source data packet when the source data packet is received at the source network device from a remote network device, and the source control packet manager generating a forged response control packet in response to detection of the source data packet;
the source network device arranged to send the forged response control packet to the remote network device;
a destination network device arranged to detect a destination response packet sent from the destination location in response to reception of the source data packet at the destination location, and to prevent sending of the destination response packet to the remote location;
wherein the forged response control packet emulates the destination response packet.

2. The network communication system as claimed in claim 1, wherein the source network device is arranged to add a custom packet header to the source data packet, the custom packet header including a forged packet flag, the destination network device detecting the forged packet flag and in response preventing sending of the destination response packet to the remote location when the destination response packet sent from the destination location is detected by the destination network device.

3. The network communication system as claimed in claim 1, wherein the source network device comprises at least one source application arranged to implement at least generation of a forged response control packet in response to detection of the source data packet.

4. The network communication system as claimed in claim 3, wherein the source network device comprises a source TUN interface arranged to provide an interface between a kernel of the source network device and the source application.

5. The network communication system as claimed in claim 3, wherein the source application is downloadable and installable on a source computing device so as to at least partially implement the source network device on the source computing device.

6. The network communication system as claimed in claim 1, wherein the destination network device comprises at least one destination application arranged to implement at least detection of a destination response packet sent from the destination location in response to reception of the source data packet at the destination location, and prevention of sending of the destination response packet to the remote location.

7. The network communication system as claimed in claim 6, wherein the destination network device comprises a destination TUN interface arranged to provide an interface between a kernel of the destination network device and the destination application.

8. The network communication system as claimed in claim 6, wherein the destination application is downloadable and installable on a destination computing device so as to at least partially implement the destination network device on the destination computing device.

9. The network communication system as claimed in claim 1, wherein the source network device comprises a source VPN network interface and the destination network device comprises a destination VPN network interface, the source and destination VPN network interfaces creating a VPN tunnel between the source and destination network devices.

10. The network communication system as claimed in claim 1, wherein payload data of the source packet is compressed using ASCII compression, and in response to compression of source packet payload data using ASCII compression, the source network device is arranged to add an ASCII compression flag to the custom packet header.

11. The network communication system as claimed in claim 10, wherein the destination network device is arranged to detect the ASCII compression flag in the custom packet header, and in response to decompress the associated ASCII compressed payload data.

12. A source network device for communicating data to a destination network device, the source network device comprising:
a source control packet manager for managing control packets that pass between the source and destination locations;
the source network device arranged to detect a source data packet when the source data packet is received at the source network device from a remote network device, and to generate a forged response control packet in response to detection of the source data packet; and
the source network device arranged to send the source data packet to a destination location and to send the forged response control packet to the remote network device.

13. A destination network device for receiving data communicated from a source network device, the destination network device arranged to detect a destination response packet sent from a destination location in response to reception of the source control packet at the destination location, and to prevent sending of the destination response packet to the remote location, wherein the forged response control packet emulates the destination response packet.
